(19) United States
(12) Patent Application Publication
(10) Pub. No.: US 2026/0035027 A1
(43) Pub. Date: Feb. 5, 2026

(54) CART MOUNTABLE GOLF CADDY

(71) Applicant: Textron Inc., Providence, RI (US)

(72) Inventors: Nicole Ashley Morris, Grovetown, GA (US); Samuel Dean Smith, Martinez, GA (US)

(73) Assignee: Textron Inc., Providence, RI (US)

(21) Appl. No.: 18/788,596

(22) Filed: Jul. 30, 2024

(51) Int. Cl. B62B 5/00; B60D 1/62; B60R 16/033; B62B 3/02; B62B 3/10; B62B 5/06

(52) U.S. Cl. CPC B62B 5/0003; B60D 1/62; B60R 16/033; B62B 3/02; B62B 3/102; B62B 5/067; B62B 2202/406

(57) ABSTRACT

A caddy system includes a caddy. The caddy includes a frame, a plurality of tractive elements coupled to the frame, and a carriage configured to receive and support a golf bag. The carriage is pivotably coupled to the frame such that a lower end of the caddy can be pivoted to a raised position to be received by the golf vehicle.

### BACKGROUND

The present application relates to a caddy for holding accessories. More specifically, the present application relates to a golf caddy for holding golf accessories that is mountable on a golf cart.

### SUMMARY

One embodiment relates to a caddy system for a golf vehicle. The caddy system includes a caddy. The caddy includes a frame, a plurality of tractive elements coupled to the frame, and a carriage configured to receive and support a golf bag. The carriage is pivotably coupled to the frame such that a lower end of the caddy can be pivoted to a raised position to be received by the golf vehicle.

Another embodiment relates to a caddy system for a golf vehicle. The caddy system includes a well configured to be coupled to the golf vehicle and a caddy. The caddy includes a frame, a plurality of tractive elements coupled to the frame, and a carriage pivotably coupled to the frame such that a lower end of the caddy can be pivoted to a raised position to be received by the well when the well is coupled to the golf vehicle.

Still another embodiment relates to a caddy system for a golf vehicle. The caddy system includes a well configured to be coupled to the golf vehicle, a retainer assembly configured to be coupled to the golf vehicle and a caddy. The retainer assembly includes a first interface. The caddy includes a frame, a plurality of tractive elements coupled to the frame, a carriage pivotably coupled to the frame such that a lower end of the caddy can be pivoted to a raised position to be received by the well when the well is coupled to the golf vehicle, and a second interface configured to releasably couple to the first interface when the lower end of the caddy is received and supported by the well.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a rear perspective view of the vehicle of FIG. 1, according to an exemplary embodiment.

FIG. 4 is a rear perspective view of a well of the vehicle of FIG. 1, according to an exemplary embodiment.

FIG. 5 is a side view of a caddy in a lowered configuration, according to an exemplary embodiment.

FIG. 6 is a back view of the caddy of FIG. 5 in the lowered configuration, according to an exemplary embodiment.

FIG. 7 is a side view of the caddy of FIG. 5 in a raised configuration, according to an exemplary embodiment.

FIG. 8 is a side view of the caddy of FIG. 5 in the raised configuration approaching the vehicle of FIG. 1, according to an exemplary embodiment.

FIG. 9 is a side view of the caddy of FIG. 5 being pivoted onto the vehicle of FIG. 1, according to an exemplary embodiment.

FIG. 10 is a side view of the caddy of FIG. 5 supported by the vehicle of FIG. 1, according to an exemplary embodiment.

FIG. 11 is a side view of the caddy of FIG. 5 supported by the vehicle of FIG. 1, according to an exemplary embodiment.

FIG. 12 is a rear perspective view of the vehicle of FIG. 1 supporting a plurality of the caddies of FIG. 5, according to an exemplary embodiment.

FIG. 13 is a schematic block diagram of the caddy of FIG. 5, according to an exemplary embodiment.

FIG. 14 is a schematic block diagram of a site monitoring and control system including a plurality of the vehicles of FIG. 1 and a plurality of the caddies of FIG. 5, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

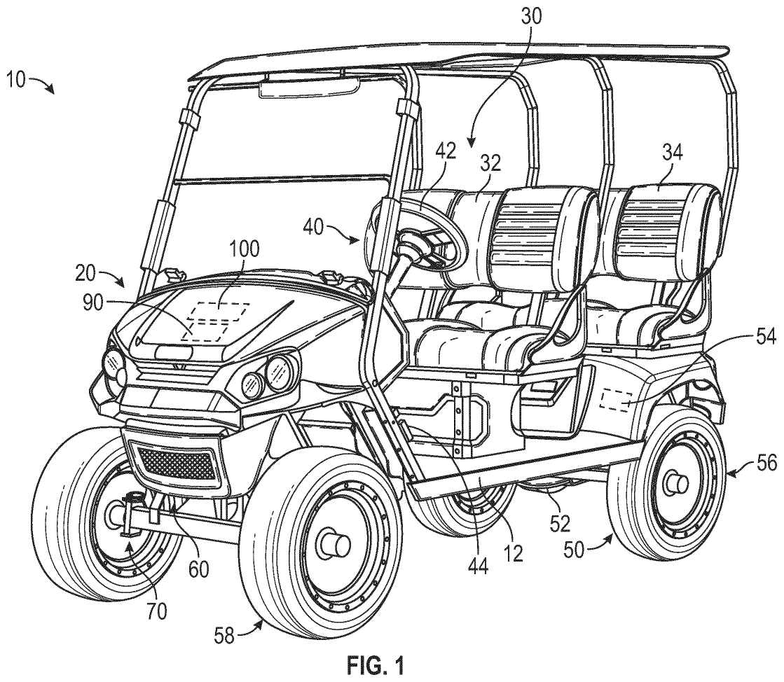

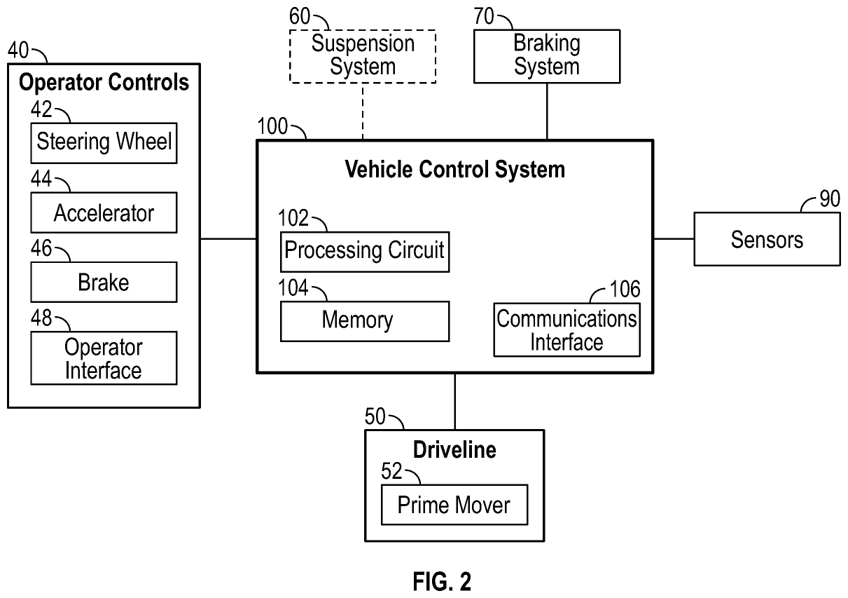

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart (e.g., a golf vehicle), an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

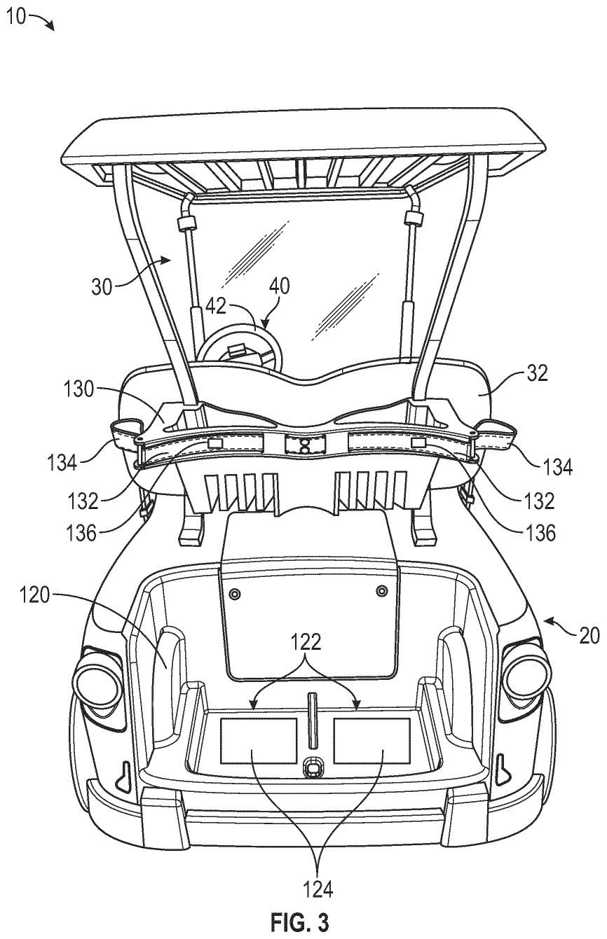

As shown in FIGS. 3, 4, and 8-12, the body 22 includes a bag well (e.g., a rear portion, a well assembly, a rear assembly, etc.), shown as well assembly 120, positioned at a rearward end of the body 20 (e.g., rearward of the front row seating 32, rearward of the rear row seating 34, etc.). In some embodiments, the well assembly 120 is included in the occupant seating area 30. According to the exemplary embodiment shown in FIGS. 3, 4, and 12, the well assembly 120 is configured to receive and support one or more caddies (e.g., two caddies, three caddies, golf caddies, golf bags, etc.). By receiving and supporting the plurality of caddies, the well assembly 120 may allow of the vehicle 10 to carry a caddy for one or more occupants of the vehicle 10. By way of example, when the occupant seating area 30 includes the front row seating 32 configured to seat two occupants, the well assembly 120 may be configured to receive and support two caddies such that the vehicle 10 may carry a caddy for each of the occupants. In other embodiments, the well assembly 120 is configured to receive and support a single caddy.

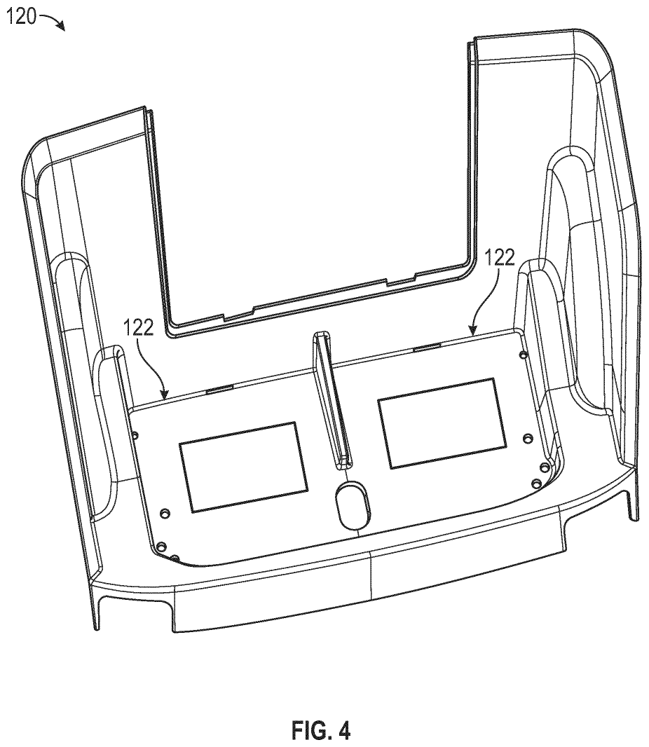

As shown in FIGS. 3 and 4, the well assembly 120 defines a plurality of caddy cavities (e.g., bag divots, bag recesses, openings, well openings etc.), shown as wells 122, configured to receive bottom portions of the caddies when the caddies are received and supported by the well assembly 120. By way of example, the wells 122 may receive the bottom portions of the caddies to prevent the bottom portions of the caddies from sliding rearwards during acceleration of the vehicle 10 (e.g., while operating the vehicle 10 through a golf course, etc.). In other embodiments, the well assembly 120 defines a single one of the wells 122 configured to receive the bottom portion of one of the caddies (e.g., when the vehicle 10 is configured to hold a single occupant, etc.). In still other embodiments, the well assembly 120 does not define the wells 122. By way of example, the bottom portions of the caddies may be supported by an upward facing surface of the well assembly 120 without being received by a portion of the well assembly 120.

As shown in FIGS. 3 and 4, the well assembly 120 includes first interface members (e.g., first latch members, first engagement members, etc.), shown as well interface members 124, configured to interface with first interfaces of the caddies. The well interface members 124 are configured to interface with the first interfaces of the caddies positioned on the bottom portions of the caddies to releasably couple the caddies to the well assembly 120 when the caddies are received by the well assembly 120. By way of example, the well interface member 124 may be configured as latch members configured to interface with latch assemblies of the caddies, hook or loop fastener portions configured to interface with hook or loop fastener portions of the caddies, or any other means configured to interface with the caddy first interfaces of the caddies positioned on the bottom portions of the caddies to releasably couple the caddies to the well assembly 120. Each of the well interface members 124 may be positioned within one of the wells 122. By way of example, the well interface members 124 may be positioned on bottom surfaces of the wells 122. In other embodiments, the well assembly 120 does not include the well interface members 124.

In some embodiments, the well interface members 124 are electrically coupled to the energy storage 54 (e.g., when the energy storage 54 is the battery system, etc.) and are configured to electrically couple to the first interfaces of the caddies when the well interface members 124 interface with the first interfaces of the caddies to couple the caddies to the well assembly 120 such that the vehicle 10 may provide electric energy (e.g., electricity, etc.) from the energy storage 54 to the caddies through the well interface members 124 (e.g., to charge batteries of the caddies, to power electrical components of the caddies, etc.). In other embodiments, the well interface members 124 are not electrically coupled to the energy storage 54 and are not configured to electrically couple to the first interfaces of the caddies.

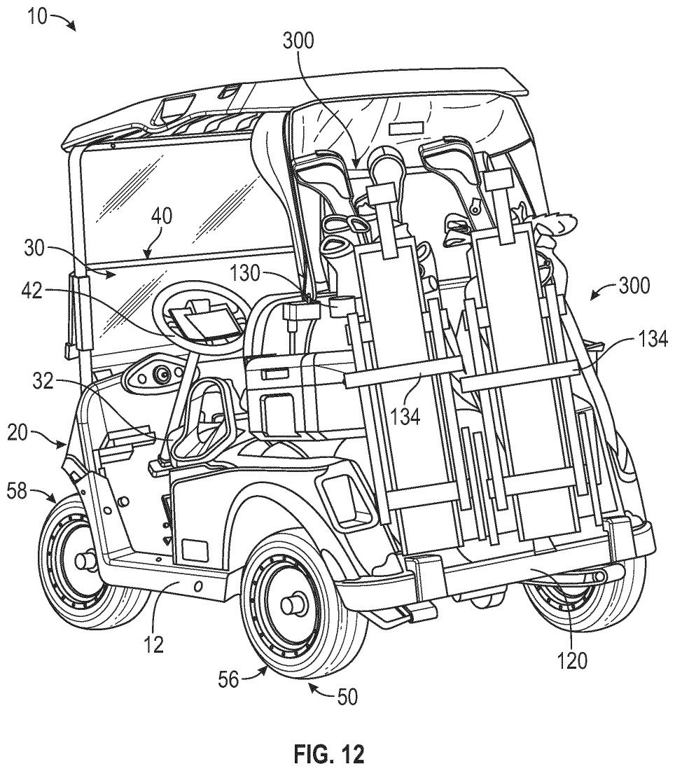

As shown in FIGS. 3, 4, and 8-12, the vehicle 10 includes a retainer (e.g., a top retention portion, an arm assembly, etc.), shown as retainer assembly 130, positioned at a rearward end of the body 20 (e.g., rearward of the front row seating 32, rearward of the rear row seating, etc.) and above the well assembly 120. According to the exemplary embodiment shown in FIGS. 3 and 12, the retainer assembly 130 is configured to interface with (e.g., support, engage with, etc.) the plurality of caddies (e.g., when the well assembly 120 is configured to receive and support the plurality of caddies, etc.). The retainer assembly 130 may interface with a top or upper portion (e.g., a top or upper end) of the plurality of caddies to support the top or upper portion of the plurality of caddies. In other embodiments, the retainer assembly 130 is configured to interface with a single one of the caddies (e.g., when the well assembly 120 is configured to receive and support the single of the caddies, etc.).

As shown in FIG. 3, the retainer assembly 130 includes a plurality of arms, shown as arms 132, configured to interface with top portions of the caddies when the caddies are received and supported by the well assembly 120. By way of example, when the wells 122 receive the bottom portions of the caddies, the top portions of the caddies may contact the arms 132 to prevent the top portions of the caddies from sliding forwards during deceleration of the vehicle 10 (e.g., while operating the vehicle 10 through a golf course, etc.). In other embodiments, the retainer assembly 130 includes a single arm 132 configured to interface with the top portion of one of the caddies (e.g., when the well assembly 120 defines a single well 122, etc.).

As shown in FIGS. 3 and 12, the retainer assembly 130 includes a plurality of first straps (e.g., arm retention straps, arm engagement straps, etc.), shown as arm straps 134, configured to be at least partially wrapped around the caddies to releasably couple the caddies to the retainer assembly 130. A first end of the arm straps 134 may be coupled to the arms 132 and a second end of the arm straps 134 may be configured to releasably couple to the arms 132 such that when the caddies are received and supported by the well assembly 120, the arm straps 134 mat be wrapped at least partially around the caddies and the second end of the arm straps 134 may be coupled to the arms 132 to releasably couple the caddies to the retainer assembly 130. In other embodiments, the retainer assembly 130 does not include the arm straps 134.

As shown in FIG. 3, the retainer assembly 130 includes second interface members (e.g., second latch members, second engagement members, etc.), shown as arm interface members 136, configured to interface with second interfaces of the caddies. The arm interface members 136 are configured to interface with the second interfaces of the caddies positioned on the top portions of the caddies to releasably couple the caddies to the retainer assembly 130 when the caddies are received and supported by the well assembly 120. By way of example, the arm interface members 136 may be configured as latch members configured to interface with latch assemblies of the caddies, hook or look fastener portions configured to interface with hook and loop fastener portions of the caddies, or any other means configured to interface with the caddy second interfaces of the caddies positioned on the top portions of the caddies to releasably couple the caddies to the retainer assembly 130. Each of the arm interface members 136 may be positioned on one of the arms 132. In other embodiments, the retainer assembly 130 does not include the arm interface members 136.

In some embodiments, the arm interface members 136 are electrically coupled to the energy storage 54 (e.g., when the energy storage 54 is the battery system, etc.) and are configured to electrically couple to the caddy second interfaces of caddies when the arm interface members 136 are engaged with the second interfaces of the caddies such that the vehicle 10 may provide electric energy from the energy storage 54 to the caddies through the arm interface members 136. In other embodiments, the arm interface members 136 are not electrically coupled to the energy storage 54 and are not configured to electrically couple to the second interfaces of the caddies. In some embodiments, the vehicle 10 includes third interface members (e.g., separate from the well interface members 124, separate from the arm interface members 136, etc.) electrically coupled to the energy storage 54 (e.g., when the energy storage 54 is the battery system, etc.) and configured to electrically couple to third interfaces when the caddies are received and supported by the well assembly 120 such that the vehicle 10 may provide electric energy from the energy storage 54 to the caddies through the third interface members.

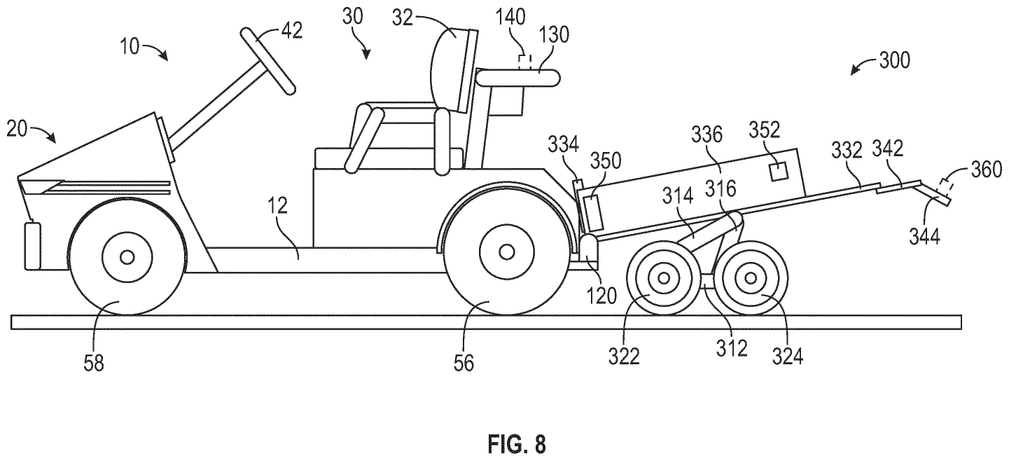

According to the exemplary embodiment shown in FIGS. 8-10 and 13, the vehicle 10 includes a first user interface (e.g., a first button, a first switch, etc.), shown as vehicle user interface 140, configured to provide an operator with the ability to control one or more functions of and/or provide commands to components of the vehicle 10 and/or the caddies supported by the vehicle 10 (e.g., release the caddies, provide electric energy to the caddies, etc.). By way of example, the vehicle user interface 140 may be a button configured to control the well interface members 124 and/or the arm interface members 136 to disengage from the caddies such that the caddies can be removed from the vehicle 10. According to the exemplary embodiment shown in FIGS. 8-10, the vehicle user interface 140 is positioned on the retainer assembly 130. In other embodiments, the vehicle user interface 140 is positioned elsewhere on the body 22 (e.g., on the well assembly 120, etc.). In still other embodiments, the vehicle 10 does not include the vehicle user interface 140.

### Caddy

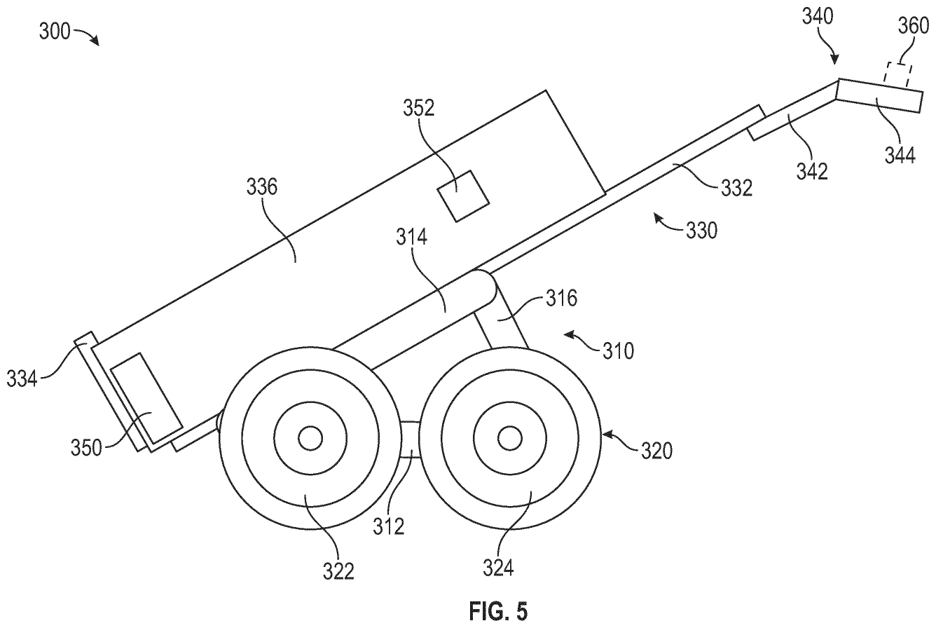

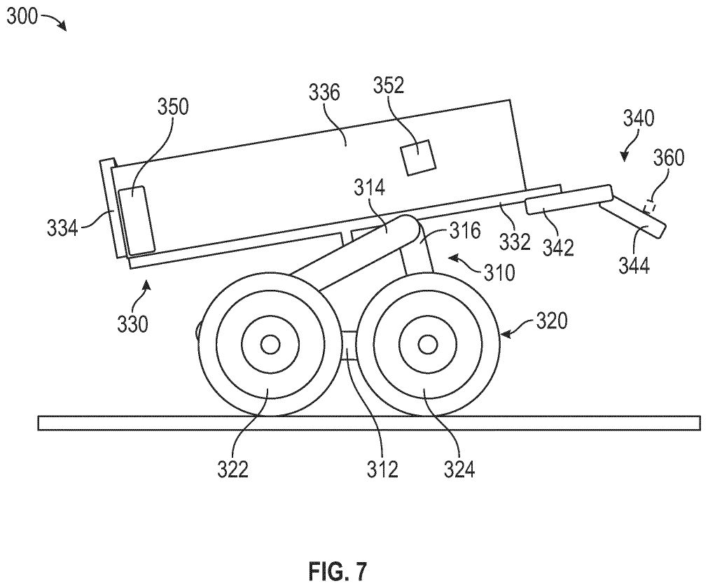

As shown in FIGS. 5-13, a bag cart or bag holder (e.g., golf caddy, golf bag holder, a caddy push cart, cart mountable caddy, mountable caddy, etc.), shown as caddy 300, is configured to be received and supported by the vehicle 10. The caddy 300 includes a chassis (e.g., a caddy chassis), shown as caddy frame 310; a drivetrain (e.g., a caddy drivetrain), shown as caddy driveline 320, coupled to the caddy frame 310; a body (e.g., a caddy body), shown as carriage 330, pivotably coupled to the caddy frame 310; a handle (e.g., a caddy handle, etc.), shown as handle assembly 340, coupled to the carriage 330; operator input devices, shown as caddy user interface 360; one or more second sensors, shown as caddy sensors 370; a battery system, shown as battery assembly 380; and a control system, shown as caddy control system 400, coupled to the caddy driveline 320, the caddy user interface 360, the caddy sensors 370, and the battery assembly 380. In some embodiments, the caddy 300 includes more or fewer components. As a result of the carriage 330 being pivotably coupled to the caddy frame 310, the carriage 330 may be pivoted upward relative to the caddy frame 310 such that a bottom portion (e.g., lowest portion, etc.) of the carriage 330 may be pushed into the wells 122 of the well assembly 120 of the vehicle 10, allowing for the bottom portion of the carriage 330 be used as a fulcrum that the caddy 300 may be pivoted about while lifting the caddy 300 to load the caddy 300 into the vehicle 10, which may decrease an amount of weight required to be lifted by an operator to load the caddy 300 into the vehicle 10 when compared with fully lifting the caddy 300 to load the caddy 300 into the vehicle 10.

According to an exemplary embodiment, the caddy 300 is a golf caddy or golf bag push cart that is configured to be received and supported by the vehicle 10 configured as a golf cart. The caddy 300 may be configured to receive and support golf bags configured to store golf clubs and/or other golfing accessories such that golfers do not have to carry the golf bags, the golf clubs, and/or the other golfing accessories when the golfers leave the vehicle 10. By way of example, while golfing, a golfer may walk away from the vehicle 10 to a location of a golf ball (e.g., when the golf course is cart path only, when the golfer cannot drive the vehicle 10 to the location of the golf ball, when two golfers traveling in the vehicle 10 split up to hit their golf balls from separate locations, etc.). When leaving the vehicle 10, the golfer may not know which golf club the golfer desires to use to hit the golf ball. Since the caddy 300 can carry the golf clubs of the golfer, the golfer can bring the caddy 300 to the location of the golf ball to have access to multiple of the golf clubs to hit the golf ball without having to carry the multiple of the golf clubs from the vehicle 10 to the location of the golf ball.

As shown in FIGS. 5-7, the caddy frame 310 includes a first portion (e.g., a wheel base portion, a first frame portion, etc.), shown as driveline portion 312, coupled to the caddy driveline 320, a second portion (e.g., a bag support portion, a carriage portion, a second frame portion, etc.), shown as carriage support portion 314, pivotably coupled to the driveline portion 312 and pivotably coupled to the carriage 330, and a third portion (e.g., a sliding portion, a collapse portion, a third frame portion, etc.), shown as sliding portion 316, pivotably coupled to driveline portion 312 and slidably coupled to the carriage support portion 314. A first end of the carriage support portion 314 is pivotably coupled to the driveline portion 312 at a first end (e.g., a forward end, etc.) of the driveline portion 312. The sliding portion 316 is pivotably coupled to the driveline portion 312 at a second opposing end (e.g., a rearward end, etc.) of the driveline portion 312. The sliding portion 316 is configured to slide along at least a portion of a length of the carriage support portion 314 from an opposing second end of the carriage support portion 314 toward the first end of the carriage support portion 314 where the carriage support portion 314 is pivotably coupled to the driveline portion 312.

According to the exemplary embodiment shown in FIGS. 5-11, the caddy frame 310 is reconfigurable between a deployed or expanded configuration and a stowed or collapsed configuration. By way of example, the caddy frame 310 may be configured to support the carriage 330 (e.g., via the caddy driveline 320, etc.) when the caddy frame 310 is in the expanded configuration and the caddy frame 310 may fold towards the carriage 330 when the caddy frame 310 is in the collapsed configuration (e.g., the caddy driveline 320 may be closer to the carriage 330 when the caddy frame 310 is in the collapsed configuration than when the caddy frame 310 is in the expanded configuration, etc.). In the expanded configuration of the caddy frame 310, the sliding portion 316 is coupled to the carriage support portion 314 proximate the second opposing end of the carriage support portion 314. By way of example, when the caddy frame 310 is in the expanded configuration, the driveline portion 312, the carriage support portion 314, and the sliding portion 316 may form a generally triangular shape or truss assembly. To reconfigure the caddy frame 310 from the expanded configuration to the collapsed configuration, the sliding portion 316 is slid along at least the portion of the length of the carriage support portion 314 in a direction from the second opposing end of the carriage support portion 314 toward the first end of the carriage support portion 314, causing the driveline portion 312 to pivot toward the carriage support portion 314 and the sliding portion 316 to pivot toward the driveline portion 312. By way of example, when the caddy frame 310 is in the collapsed configuration, the driveline portion 312, the carriage support portion 314, and the sliding portion 316 may be oriented parallel or substantially parallel with each other.

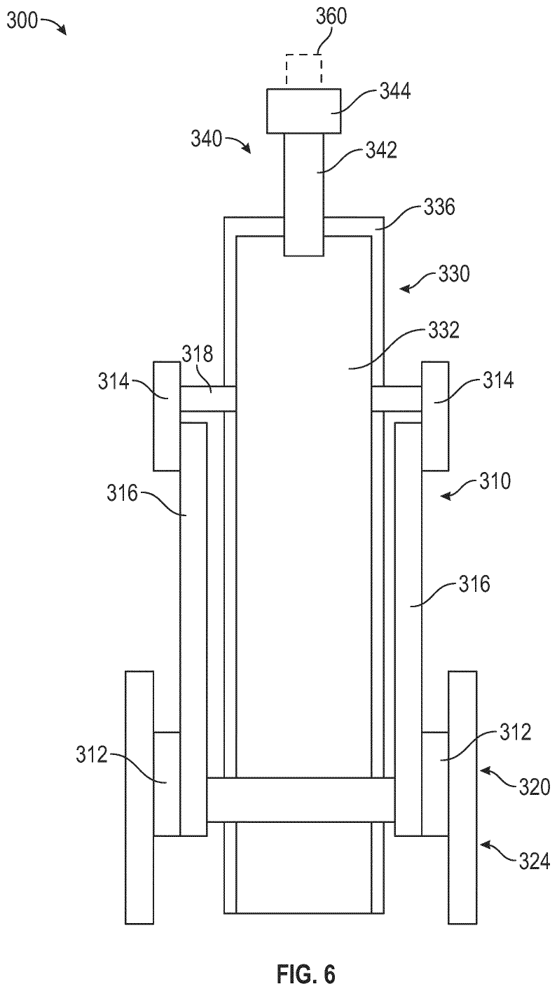

As shown in FIG. 6, the driveline portion 312 includes a first driveline member positioned on a first side (e.g., a left side, etc.) of the caddy frame 310 and a second driveline member positioned on a second side (e.g., a right side, etc.) of the caddy frame 310, the carriage support portion 314 includes a first carriage support member positioned on the first side of the caddy frame 310 and a second carriage support member positioned on the second side of the caddy frame 310, and the sliding portion 316 includes a first sliding member positioned on the first side of the caddy frame 310 and a second sliding member positioned on the second side of the caddy frame 310. According to the exemplary embodiment shown in FIG. 6, the first driveline member and the second driveline member of the driveline portion 312 and the first carriage support member and the second carriage support member of the carriage support portion 314 are positioned outward from the first sliding member and the second sliding member of the sliding portion 316. In some embodiments, the components of the driveline portion 312 are positioned outward from the components of the carriage support portion 314. In other embodiments, the components of the carriage support portion 314 are positioned outward from the components of the driveline portion 312. In still other embodiments, the components of the sliding portion 316 are positioned outward from the components of the driveline portion 312 and/or the carriage support portion 314.

As shown in FIG. 6, the caddy 300 includes a locking portion (e.g., an anti-rotation assembly, a locking mechanism, etc.), shown as locking assembly 318, coupled between the caddy frame 310 and the carriage 330 and configured to selectively allow for the carriage 330 to be pivoted relative to the caddy frame 310. In some embodiments, the locking assembly 318 is configured to be reconfigurable between an unlocked configuration that allows for the carriage 330 to be pivoted relative to caddy frame 310 and a locked configuration that limits the pivoting of the carriage 330 relative to the caddy frame 310. By way of example, when the locking assembly 318 is in the unlocked configuration, the carriage 330 may be pivoted from the lowered configuration towards the raised configuration and from the raised configuration to the lowered configuration. When the locking assembly 318 is in the locked configuration, the carriage 330 may still be pivoted from the raised configuration toward the lowered configuration, but the locking assembly 318 may prevent the pivoting of the carriage 330 from the lowered configuration towards the raised configuration.

The caddy driveline 320 is configured to support the caddy frame 310 above a ground surface and allow for the caddy 300 to be propelled, pushed, or pulled along the ground surface. As shown in FIGS. 5-11, the caddy driveline 320 includes a first caddy tractive assembly (e.g., axles, wheels, tracks, etc.), shown as caddy front tractive assembly 322, coupled to the driveline portion 312 at a first location, and a second caddy tractive assembly (e.g., axles, wheels, tracks, etc.), shown as caddy rear tractive assembly 324, coupled to the driveline portion 312 at a second location positioned rearward of the first location. According to the exemplary embodiment shown in FIGS. 5-14, the caddy front tractive assembly 322 includes caddy front tractive elements (e.g., two caddy front tractive elements, etc.) and the caddy rear tractive assembly 324 includes caddy rear tractive elements (e.g., two caddy rear tractive elements, etc.) that are configured as wheels. In some embodiments, the caddy front tractive elements and/or the caddy rear tractive elements are configured as tracks. In other embodiments, the caddy driveline 320 includes additional caddy tractive assemblies (e.g., a third cady tractive assembly, etc.) positioned between the caddy front tractive assembly 322 and the caddy rear tractive assembly 324. In still other embodiments, the caddy driveline 320 includes one of the caddy front tractive assembly 322 or the caddy rear tractive assembly 324. By way of example, when the caddy driveline 320 includes the caddy front tractive assembly 322 and does not include the caddy rear tractive assembly 324, the caddy 300 may be cantilevered around the caddy front tractive assembly 322 and an operator of the caddy 300 may support a portion of the caddy 300 (e.g., via the handle assembly 340, etc.). When the caddy driveline 320 includes one of the caddy front tractive assembly 322 or the caddy rear tractive assembly 324, the caddy 300 may include a stand configured to engage the ground surface to stabilize the caddy 300 when the operator is not supporting the portion of the caddy 300 (e.g., when the user is hitting a golf ball, etc.). By way of example, the stand may be pivotably coupled to the caddy frame 310 and/or the carriage 330 so that the operator may pivot the stand down to engage the ground surface to support the caddy 300 when the caddy 300 is stationary and may pivot the stand up to not engage the ground surface when the operator is propelling the caddy 300.

According to an exemplary embodiment, when the caddy frame 310 is adjusted between the collapsed configuration and the expanded configuration, a lateral position of the caddy front tractive assembly 322 and the caddy rear tractive assembly 324 relative to the carriage 330 does not change. By way of example, as the caddy frame 310 is adjusted between the collapsed configuration and the expanded configuration, the caddy rear tractive assembly 324 does not move inward or outward relative to the carriage 330 such that a first width of the caddy rear tractive assembly 324 when the caddy frame 310 is in the collapsed configuration is equal to a second width of the caddy rear tractive assembly 324 when the caddy frame 310 is in the expanded configuration. In other embodiments, as the caddy frame 310 is adjusted between the collapsed configuration and the expanded configuration, the lateral position of the caddy front tractive assembly 322 and/or the caddy rear tractive assembly 324 changes relative to the caddy 300. By way of example, when the caddy frame 310 is adjusted between the collapsed configuration and the expanded configuration, the caddy front tractive assembly 322 and/or the caddy rear tractive assembly 324 may move outward relative to the carriage 330 such that a first width of the caddy front tractive assembly 322 and/or the caddy rear tractive assembly 324 is less when the caddy frame 310 is in the collapsed configuration than a second width of the caddy front tractive assembly 322 and/or the caddy rear tractive assembly 324 when the caddy frame 310 is in the expanded configuration. By changing the lateral position of the caddy front tractive assembly 322 and/or the caddy rear tractive assembly 324, the caddy frame 310 may allow for a wheelbase width of the caddy front tractive assembly 322 and/or the caddy rear tractive assembly 324 that contacts the ground surface to be wider than a storage width of the caddy front tractive assembly 322 and/or the caddy rear tractive assembly 324 when the caddy 300 is supported by the vehicle 10.

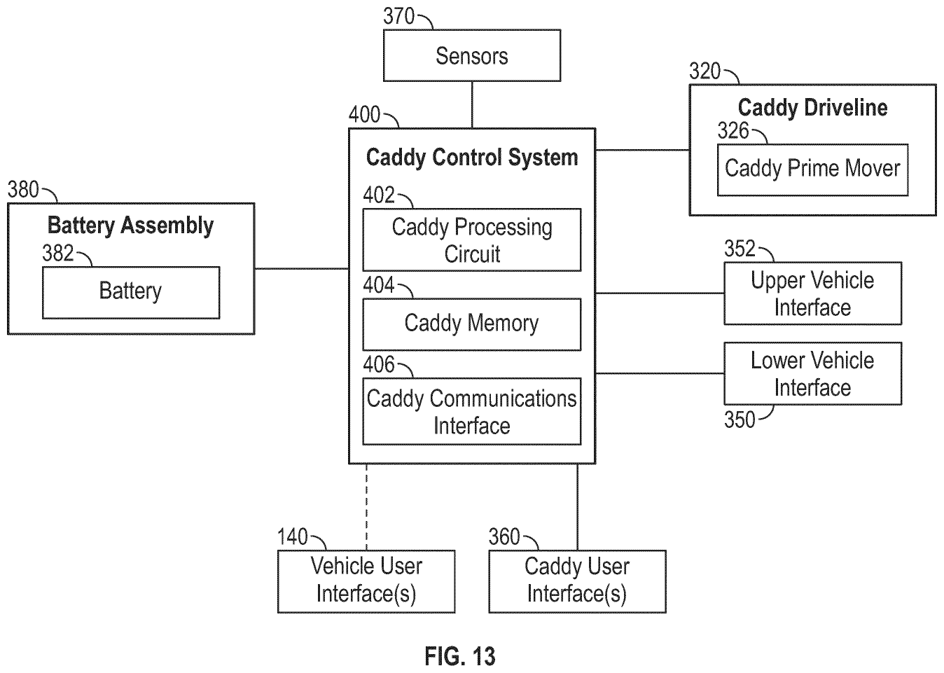

In some embodiments, as shown in FIG. 13, the caddy driveline 320 includes a caddy primary driver, shown as caddy prime mover 326, configured to drive the caddy front tractive assembly 322 and/or the caddy rear tractive assembly 324 to propel the caddy 300. In some embodiments, the caddy driveline 320 is an electric driveline where the caddy prime mover 326 is an electric motor that receives electric energy from the battery assembly 380 to propel the caddy 300.

As shown in FIGS. 5-11, the carriage 330 includes a first portion (e.g., frame portion, etc.), shown as carriage frame 332, pivotably coupled to the carriage support portion 314 and a second portion (e.g., foot portion, etc.), shown as carriage foot 334, extending from a first, lower end of the carriage frame 332. According to the exemplary embodiment shown in FIGS. 5, 7, and 8, the carriage foot 334 extends generally perpendicularly from the first, lower end of the carriage frame 332. The carriage 330 is configured to pivot relative to the caddy frame 310 between a travel configuration where the carriage frame 332 rests on the caddy frame 310 and a raised configuration where the carriage 330 is pivoted relative to the caddy frame 310 such that the first, lower end of the carriage frame 332 is lifted away from the carriage support portion 314. As shown in FIG. 5, in the travel configuration, at least a portion of the carriage frame 332 rests and extends along a length of the carriage support portion 314 of the caddy frame 310 and in the raised configuration, carriage frame 332 pivots relative to the caddy frame 310 and is lifted off of the carriage support portion 314.

As shown in FIGS. 5-7, the carriage 330 includes a storage portion (e.g., a golf bag, etc.), shown as bag 336, received and supported by the carriage frame 332 and the carriage foot 334. In some embodiments, the bag 336 is coupled to the carriage frame 332 and/or the carriage foot 334. By way of example, a bottom portion of the bag 336 may be supported by and/or coupled to the carriage foot 334 and a side portion of the bag 336 may be supported by and/or coupled to the carriage frame 332. The bag 336 defines a bag opening (e.g., an opening, etc.) configured to receive accessories so that the caddy 300 can carry the accessories. By way of example, the bag opening of the bag 336 may be divided into several different compartments configured to receive golf clubs and/or other golf accessories such that the caddy 300 can carry the golf clubs and/or other golf accessories. In other embodiments, the carriage 330 does not include the bag 336 and the carriage 330 is configured to receive and support various bags 336. By way of example, the carriage 330 may receive and support a first of the bags 336 of a first operator while the first operator is using the caddy 300 and the carriage 330 may receive and support a second of the bag 336 of a second operator while the second operator is using the caddy 300 such that each of the operators may use their own bag 336 while using the caddy 300. In some embodiments, the bag 336 may be releasably coupled to the carriage 330. By way of example, the carriage 330 may include a strap configured to be at least partially wrapped around the bag 336 to couple the bag 336 to the carriage 330.

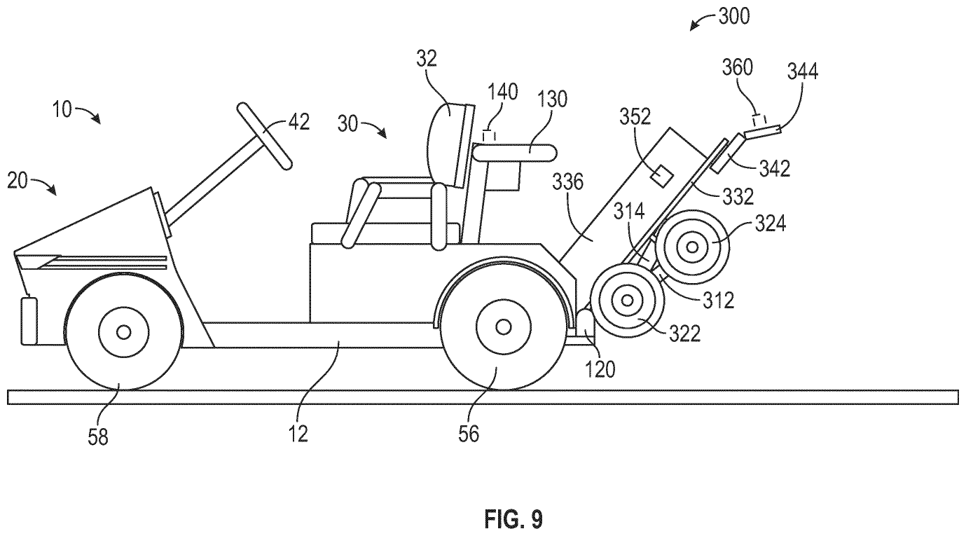

As shown in FIGS. 8-11, the pivoting of the carriage 330 relative to the caddy frame 310 can be used to load the caddy 300 into the vehicle 10. As shown in FIG. 8, the carriage 330 can be pivoted from the travel configuration to the raised configuration such that a bottom portion of the carriage 330 (e.g., the carriage foot 334, a lower portion of the carriage frame 332, the first end of the carriage 330, etc.) is positioned higher than the wells 122 of the well assembly 120 of the vehicle 10 (e.g., above a lip of the well assembly 120 defining the wells 122, etc.). Once the carriage 330 is in the raised configuration, the caddy 300 can be propelled forward such that the bottom portion of the carriage 330 is positioned above (e.g., directly above, etc.) one of the wells 122 of the well assembly 120 and the carriage 330 may be pivoted such that the bottom portion of the carriage 330 is received by the one of the wells 122 of the well assembly 120. As shown in FIG. 9, once the bottom portion of the carriage 330 is received by the one of the wells 122 of the well assembly 120, an operator may lift an upper portion of the carriage 330 such that the caddy 300 pivots upward toward the vehicle 10 about a point of contact between the carriage 330 and the well assembly 120. Since the bottom portion of the carriage 330 has been received by the wells 122 and is supported by the well assembly 120, the operator does not lift an entire weight of the caddy 300 while pivoting the caddy 300 upward toward the vehicle 10, which may assist the operator with loading the caddy 300 into the vehicle 10.

Additionally, as shown in FIGS. 8-10, as the caddy 300 is pivoted toward the vehicle 10, the caddy frame 310 may be collapsed from the expanded configuration into the collapsed configuration to reduce a length of the caddy 300 in a direction of travel of the vehicle 10 when the caddy 300 is loaded into the caddy 300. In some embodiments, when the caddy frame 310 is in the collapsed configuration and the caddy 300 is loaded into the vehicle 10, the caddy 300 may not extend rearward of a rearmost portion of the vehicle 10 (e.g., a rearmost portion of the well assembly 120, etc.). When unloading the caddy 300 from the vehicle 10, the loading operation of the caddy 300 can be reversed, with the operator pivoting the caddy 300 downward away from the vehicle 10 about the point of contact between the carriage 330 and the well assembly 120 and expanding the caddy frame 310 from the collapsed configuration into the expanded configuration. Once the caddy driveline 320 is supported by the ground surface, the operator may pivot the carriage 330 upward relative to the caddy frame 310 to remove the bottom portion of the carriage 330 from the wells 122 such that the caddy 300 can be propelled backward such that the bottom portion of the carriage 330 is no longer positioned above the wells 122 of the well assembly 120. The operator can then pivot the carriage 330 downward relative to the caddy frame 310 from the raised configuration to the travel configuration so that the caddy 300 can be propelled to a desired location away from the vehicle 10.

As shown in FIGS. 5-11, the handle assembly 340 includes an extension portion (e.g., a collapsing portion, a telescoping portion, etc.), shown as handle extension 342, coupled to an opposing second end of the carriage frame 332, and a handle portion, shown as handle 344, coupled to the handle extension 342 and configured to be grasped by the operator of the caddy 300. According to the exemplary embodiment shown in FIGS. 8-11, the handle extension 342 is slidably coupled to the carriage frame 332 and can slide relative to the carriage frame 332 to move the handle 344 between a retracted position that positions the handle 344 a first distance from the carriage frame 332 and an extended positioned that positions the handle 344 a second distance from the carriage frame 332 that is greater than the first distance. In other embodiments, the handle extension 342 is configured as a telescoping handle extension that can extend and retract to position the handle 344 in the retracted position or the extended portion. In still other embodiments, the handle assembly 340 does not include the handle extension 342 and the handle 344 is directly coupled to the carriage frame 332.

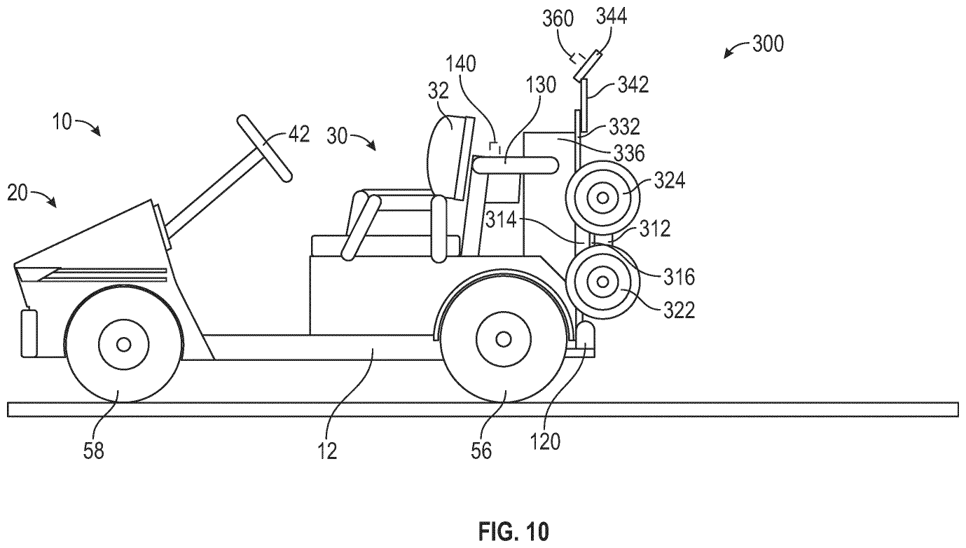

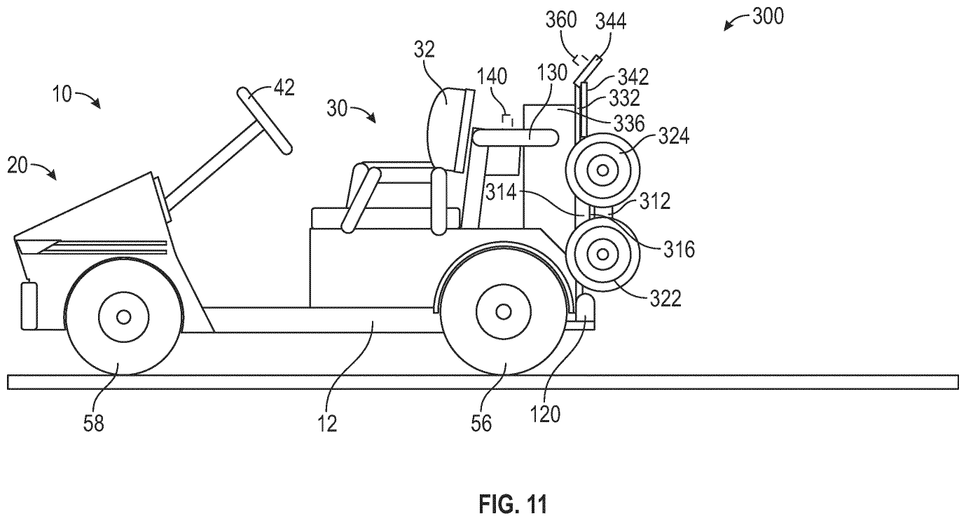

As shown in FIGS. 10 and 11, when the caddy 300 is loaded into the vehicle 10, the handle extension 342 may be operated to place the handle 344 in the retracted position to reduce a height of the caddy 300. By way of example, the handle extension 342 may be operated to place the handle 344 in the retracted position to move the handle 344 out of a rear view of an operator of the vehicle 10. As another example, the handle extension 342 may be operated to place the handle 344 in the retracted position while the caddy 300 is being loaded into the vehicle 10 to prevent the handle 344 from coming into contact with a component of the vehicle 10 (e.g., a roof of the vehicle 10, etc.) while the caddy 300 is loaded into the vehicle 10.

As shown FIGS. 5, 7, 8, and 13, the caddy 300 includes a caddy first interface (e.g., caddy first latch members, caddy first engagement members, a caddy interface etc.), shown as lower vehicle interface 350, configured to interface with the well interface members 124 of the well assembly 120 of the vehicle 10. The lower vehicle interface 350 is configured to interface with the well interface members 124 to releasably couple the caddy 300 to the well assembly 120 when the caddy 300 is received and supported by the well assembly 120. By way of example, the lower vehicle interface 350 may be a latch assembly configured to interface with latch members of the well interface members 124, a hook or loop fastener portion configured to interface with hook and loop fastener portions of the well interface members 124, or any other means configured to interface with the well interface members 124 of the well assembly 120 to couple the caddy 300 to the well assembly 120 when the caddy 300 is received and supported by the well assembly 120. As shown in FIGS. 5, 7, and 8, the lower vehicle interface 350 is positioned on a lower portion of the bag 336 of the carriage 330. In some embodiments, the lower vehicle interface 350 is positioned on a lower portion of the carriage 330 (e.g., on the carriage foot 334, on a lower portion of the carriage frame 332, etc.). In other embodiments, the lower vehicle interface 350 is positioned on a lower portion of the caddy frame 310 (e.g., the driveline portion 312, the carriage support portion 314, the sliding portion 316, etc.). In still other embodiments, the caddy 300 does not include the lower vehicle interface 350. By way of example, the caddy 300 may not include the lower vehicle interface 350 when the retainer assembly 130 of the vehicle 10 includes the arm straps 134 configured to wrap around the caddy 300 to couple the caddy 300 to the vehicle 10.

In some embodiments, the lower vehicle interface 350 is electrically coupled to the battery assembly 380 and is configured to electrically couple to the well interface members 124 when the lower vehicle interface 350 is coupled to the well interface members 124 such that the vehicle 10 may provide electric energy from the energy storage 54 to the battery assembly 380 of the caddy 300 through one of the well interface members 124 and the lower vehicle interface 350 to charge the battery assembly 380 of the caddy 300. In other embodiments, the lower vehicle interface 350 is not electrically coupled to the battery assembly 380 and is not configured to electrically couple to the well interface members 124 when the lower vehicle interface 350 is coupled to the well interface members 124.

As shown FIGS. 5, 7, 8, and 13, the caddy 300 includes a caddy second interface (e.g., caddy second latch members, caddy second engagement members, etc.), shown as upper vehicle interface 352 upper vehicle interface 352, configured to interface with the arm interface members 136 of the retainer assembly 130 of the vehicle 10. The upper vehicle interface 352 is configured to interface with the arm interface members 136 to releasably couple the caddy 300 to the retainer assembly 130 when the caddy 300 is received and supported by the well assembly 120. By way of example, the upper vehicle interface 352 may be a latch assembly configured to interface with latch members of the arm interface members 136, a hook or loop fastener portion configured to interface with hook and loop fastener portions of the arm interface members 136, a snap-fit retention system, or any other means configured to interface with the arm interface members 136 of the retainer assembly 130 to couple the caddy 300 to the retainer assembly 130 when the caddy 300 is received and supported by the well assembly 120. As shown in FIGS. 5, 7, and 8, the upper vehicle interface 352 is positioned on an upper portion of the bag 336 of the carriage 330. In some embodiments, the upper vehicle interface 352 is positioned on an upper portion of the carriage 330 (e.g., on an upper portion of the carriage frame 332, etc.). In other embodiments, the lower vehicle interface 350 is positioned on an upper portion of the caddy frame 310 (e.g., the driveline portion 312, the carriage support portion 314, the sliding portion 316, etc.) or on the handle assembly 340. In still other embodiments, the caddy 300 does not include the upper vehicle interface 352.

In some embodiments, the upper vehicle interface 352 is electrically coupled to the battery assembly 380 and is configured to electrically couple to the arm interface members 136 when the upper vehicle interface 352 is coupled to the arm interface members 136 such that the vehicle 10 may provide electric energy from the energy storage 54 to the battery assembly 380 of the caddy 300 through one of the arm interface members 136 and the upper vehicle interface 352 to charge the battery assembly 380 of the caddy 300. In other embodiments, the upper vehicle interface 352 is not electrically coupled to the battery assembly 380 and is not configured to electrically couple to the arm interface members 136 when the upper vehicle interface 352 is coupled to the arm interface members 136.

In some embodiments, the caddy 300 includes a caddy third interface member (e.g., separate from the lower vehicle interface 350, separate from the upper vehicle interface 352, etc.) electrically coupled to the battery assembly 380 and configured to electrically couple to the third interface members of the vehicle 10 when the caddy 300 is received and supported by the well assembly 120 such that the vehicle 10 may provide electric energy from the electrical energy storage to the battery assembly 380 of the caddy 300 through one of the third interface members of the vehicle 10 and the caddy third interface member to charge the battery assembly 380 of the caddy 300. In various embodiments, the caddy 300 includes the caddy third interface member electrically coupled to the battery assembly 380 and configured to electrically couple to an external power source (e.g., a wall outlet, a generator, etc.) to provide electric energy from the external power source to the battery assembly 380 to charge the battery assembly 380.

As shown in FIGS. 5-11 and 13, the caddy 300 includes a second user interface (e.g., a second button, a second switch, etc.), shown as caddy user interface 360, configured to provide an operator with the ability to control one or more functions of and/or provide commands to components of the caddy 300 and/or components of the vehicle 10 when the caddy 300 is supported by the vehicle 10 (e.g., disengage the lower vehicle interface 350 from the well interface members 124, disengage the upper vehicle interface 352 from the arm interface members 136, allow the handle extension 342 to move the handle 344 between the retracted position and the extended position, allow the caddy frame 310 to move between the expanded configuration and the retracted configuration, move the locking assembly 318 between the locked configuration and the unlocked configuration, etc.). By way of example, the caddy user interface 360 may be a button configured to control the lower vehicle interface 350 and/or the upper vehicle interface 352 to disengage from the well interface members 124 and/or the arm interface members 136 such that the caddy 300 can be removed from the vehicle 10. According to the exemplary embodiment shown in FIGS. 5-11, the caddy user interface 360 is positioned on the handle 344 of the handle assembly 340 of the caddy 300. In other embodiments, the caddy user interface 360 is positioned elsewhere on the caddy 300 (e.g., on the carriage 330, on the caddy driveline 320 on the caddy frame 310, etc.). In still other embodiments, the caddy 300 does not include the caddy user interface 360. In some embodiments, the caddy 300 includes a plurality of the caddy user interfaces 360, each configured to control one or more of the functions described above.

The caddy sensors 370 may include various sensors positioned about the caddy 300 to acquire caddy information or caddy data regarding operation of the caddy 300 and/or the location thereof. By way of example, the caddy sensors 370 may include an accelerometer, a gyroscope, a compass, a position sensor (e.g., a GPS sensor, etc.), an IMU, suspension sensor(s), wheel sensors, an audio sensor or microphone, a camera, an optical sensor, a proximity detection sensor, and/or other sensors to facilitate acquiring caddy information or caddy data regarding operation of the caddy 300 and/or the location thereof. According to an exemplary embodiment, one or more of the caddy sensors 370 are configured to facilitate detecting and obtaining caddy telemetry data including position of the caddy 300, whether the caddy 300 is moving, travel direction of the caddy 300, slope of the caddy 300, speed of the caddy 300, vibrations experienced by the caddy 300, sounds proximate the caddy 300, location of the caddy 300 relative to the vehicle 10, and/or other caddy telemetry data.

As shown in FIG. 13, the battery assembly 380 includes a battery cell, shown as battery 382, configured to store electrical energy and provide the electrical energy to components of the caddy 300 (e.g., the caddy prime mover 326, the lower vehicle interface 350, the upper vehicle interface 352, the caddy user interface 360, the caddy sensors 370, etc.) to operate the components of the caddy 300. In some embodiments, the battery 382 is electrically coupled to the lower vehicle interface 350 and is configured to receive electrical energy from the vehicle 10 through the well interface members 124 when the lower vehicle interface 350 is coupled to the well interface members 124 to charge the battery 382. In some embodiments, the battery 382 is electrically coupled to the upper vehicle interface 352 and is configured to receive electrical energy from the vehicle 10 through the arm interface members 136 when the upper vehicle interface 352 is coupled to the arm interface members 136 to charge the battery 382. In other embodiments, the battery 382 is electrically coupled to the caddy third interface of the caddy 300 and is configured to receive electric energy from the caddy third interface (e.g., from the energy storage 54 of the vehicle 10, from the external power source, etc.) to charge the battery 382.

The caddy control system 400 may be implemented as a general-purpose processor, an ASIC, one or more FPGAs, a DSP, circuits containing one or more processing components, circuitry for supporting a microprocessor, a group of processing components, or other suitable electronic processing components. According to the exemplary embodiment shown in FIG. 13, the caddy control system 400 includes a caddy processing circuit 402, a caddy memory 404, and a caddy communications interface 406. The caddy processing circuit 402 may include an ASIC, one or more FPGAs, a DSP, circuits containing one or more processing components, circuitry for supporting a microprocessor, a group of processing components, or other suitable electronic processing components. In some embodiments, the caddy processing circuit 402 is configured to execute computer code stored in the caddy memory 404 to facilitate the activities described herein. The caddy memory 404 may be any volatile or non-volatile or non-transitory computer-readable storage medium capable of storing data or computer code relating to the activities described herein. According to an exemplary embodiment, the caddy memory 404 includes computer code modules (e.g., executable code, object code, source code, script code, machine code, etc.) configured for execution by the caddy processing circuit 402. In some embodiments, the caddy control system 400 may represent a collection of processing devices. In such cases, the caddy processing circuit 402 represents the collective processors of the devices, and the caddy memory 404 represents the collective storage devices of the devices.

In one embodiment, the caddy control system 400 is configured to selectively engage, selectively disengage, control, or otherwise communicate with components of the caddy 300 and/or the vehicle 10 (e.g., via the caddy communications interface 406, a CAN bus, etc.). According to an exemplary embodiment, the caddy control system 400 is coupled to (e.g., communicably coupled to) components of the caddy driveline 320 (e.g., the caddy prime mover 326, etc.), components of the battery assembly 380 (e.g., the battery 382, etc.), the vehicle control system 100, the caddy sensors 370, the vehicle user interface 140, the lower vehicle interface 350, the upper vehicle interface 352 upper vehicle interface 352, and the caddy user interface 360. By way of example, the caddy control system 400 may send and receive signals (e.g., control signals, location signals, etc.) with components of the caddy driveline 320, components of the battery assembly 380, the vehicle control system 100, the caddy sensors 370, the vehicle user interface 140, the lower vehicle interface 350, the upper vehicle interface 352, and the caddy user interface 360 and/or remote systems or devices (via the caddy communications interface 406 as described in greater detail herein).

According to an exemplary embodiment, the caddy control system 400 is configured to selectively engage and/or selectively disengage the lower vehicle interface 350 from the well interface members 124 and/or the upper vehicle interface 352 from the arm interface members 136 based on an input received from the caddy user interface 360. By way of example, the caddy user interface 360 may include a button associated with disengaging the lower vehicle interface 350 from the well interface members 124 and/or the upper vehicle interface 352 from the arm interface members 136. When a user presses the button, the caddy user interface 360 may send data to the caddy control system 400 associated with the user pressing the button. Based on receiving the data associated with the user pressing the button, the caddy control system 400 may operate the lower vehicle interface 350 to disengage from the well interface members 124 and/or operate the upper vehicle interface 352 to disengage from the arm interface members 136 so that the user can unload the caddy 300 from the vehicle 10. In other embodiments, the caddy control system 400 is configured to selectively engage and/or selectively disengage the lower vehicle interface 350 from the well interface members 124 and/or the upper vehicle interface 352 from the arm interface members 136 based on data received from the vehicle user interface 140. In still other embodiments, the vehicle control system 100 is configured to operate the well interface members 124 to disengage from the lower vehicle interface 350 and/or operate the arm interface members 136 to disengage from the upper vehicle interface 352 based on a first input received from the vehicle user interface 140 and/or a second input received from the caddy user interface 360.

According to an exemplary embodiment, the caddy control system 400 is configured to prevent the lower vehicle interface 350 from disengaging from the well interface members 124 and/or prevent the upper vehicle interface 352 from disengaging from the arm interface members 136 based on sensor data received from the caddy sensors 370. By way of example, the caddy control system 400, may receive telemetric data from the caddy sensors 370 associated with the caddy 300 traveling at a speed that is above a predetermined speed threshold, which may indicate that the caddy 300 is loaded onto the vehicle 10 and the vehicle 10 is traveling at the speed above the predetermined speed threshold. Based on the telemetric data indicating that the speed of the caddy 300 is above the predetermined speed threshold, the caddy control system 400 may prevent the lower vehicle interface 350 from disengaging from the well interface members 124 and/or prevent the upper vehicle interface 352 from disengaging from the arm interface members 136 so that the caddy 300 is not unintentionally removed from the vehicle 10 while the vehicle 10 is driving.

### Site Monitoring and Control System

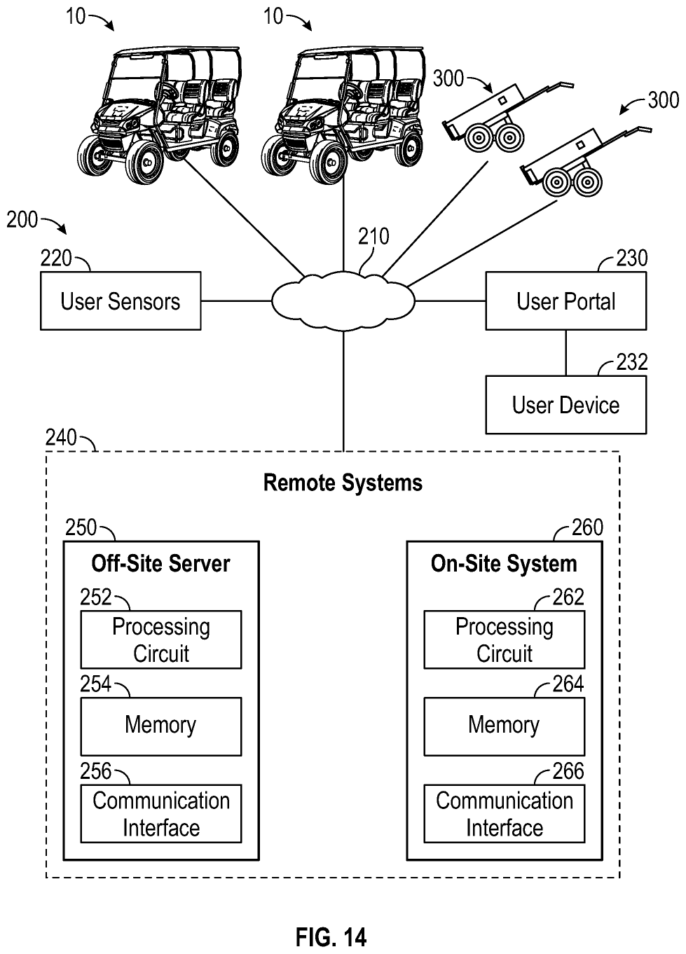

As shown in FIG. 14, a monitoring and control system, shown as site monitoring and control system 200, includes one or more of the vehicles 10; one or more of the caddies 300; one or more second sensors, shown as user sensors 220, positioned remote or separate from the vehicles 10 and the caddies 300; an operator interface, shown as user portal 230, positioned remote or separate from the vehicles 10 and the caddies 300; an external or remote user device, shown as user device 232, positioned remote or separate from the vehicles 10 and the caddies 300; and one or more external processing systems, shown as remote systems 240, positioned remote or separate from the vehicles 10 and the caddies 300. The vehicles 10, the caddies 300, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10 and/or one of the caddies 300. By way of example, the user sensors 220 may be or include a wearable sensor (e.g., a smartwatch, a fitness tracker, a pedometer, heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the caddies 300, directly with the remote systems 240, and/or indirectly with the remote systems 240 (e.g., through the vehicles 10 as an intermediary, through the caddies 300 as an intermediary, etc.).

The user portal 230 may be configured to facilitate operator access to dashboards including the vehicle data, the caddy data, the operator data, information available at the remote systems 240, etc. to manage and operate the site (e.g., golf course) such as for advanced scheduling purposes, to identify persons braking course guidelines or rules, to monitor locations of the vehicles 10, to monitor locations of the caddies 300, etc. The user portal 230 may also be configured to facilitate operator implementation of configurations and/or parameters for the vehicles 10, operator implementation of configurations and/or parameters for the caddies 300, and/or the site (e.g., setting speed limits, setting geofences, etc.). As shown in FIG. 14, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 14, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 14, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10, the caddies 300, and/or the user sensors 220 via the communications network 210. By way of example, the remote systems 240 may receive the vehicle data from the vehicles 10, the caddy data from the caddies 300, and/or the operator data from the user sensors 220. The remote systems 240 may be configured to perform back-end processing of the vehicle data, the caddy data, and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10, the caddies 300, and/or the user sensors 220. The remote systems 240 may be configured to transmit information, data, commands, and/or instructions to the vehicles 10 and/or the caddies 300. By way of example, the remote systems 240 may be configured to transmit GPS data and/or RTK data based on the GPS information and/or RTK information to the vehicles 10 and/or the caddies 300 (e.g., which the vehicle control systems 100 may use to make control decisions, which the caddy control systems 400 may use to make control decisions, etc.). By way of another example, the remote systems 240 may send commands or instructions to the vehicles 10 and/or the caddies 300 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10, the caddies 300, and/or the operators thereof and/or (b) configuring or setting operating parameters for the vehicles 10 and/or the caddies 300 (e.g., geofences, speed limits, times of use, permitted operators, etc.). Such operating parameters may be propagated to the vehicles 10 and/or the caddies 300 by the remote systems 240 (e.g., as updates to settings) and/or used for real time control of the vehicles 10 and/or the caddies 300 by the remote systems 240.

According to an exemplary embodiment, the remote systems 240 and/or the caddy control system 400 of the caddy 300 is configured to generate commands or instructions that cause the caddy 300 to follow the operator of the one of the vehicles 10 and/or that the operator carrying or wearing one of the user sensors 220 associated with or connected to the caddy 300. By way of example, the remote systems 240 and/or the caddy control system 400 may be configured to monitor various GPS and/or RTK information associated with the one of the user sensors 220 to determine a first position of the operator. Based on the first position of the operator and a second position of the caddy 300 determined based on the various GPS and/or RTK information associated with the caddy 300, the remote systems 240 and/or the caddy control system 400 may determine commands or instructions for the caddy 300 to drive the caddy 300 from the second position of the caddy 300 towards the first position of the operator. The commands or instructions may include control inputs for the caddy driveline 320 that cause the caddy driveline 320 to propel the caddy 300 from the second position of the caddy 300 towards the first position of the operator. As a result, the remote systems 240 and/or the caddy control system 400 may operate the caddy 300 to follow the operator such that the caddy 300 can be easily accessed by the operator. In some embodiments, the remote systems 240 and/or the caddy control system 400 are configured to generate commands or instructions that cause the caddy 300 to follow the operator based on sensor data received from the caddy sensors 370. By way of example, the caddy sensors 370 may include a camera configured to generate image data associated with the operator and the caddy control system 400 may determine a position of the operator and operate the caddy 300 to follow the operator based on the image data. As another example, the user sensors 220 may be configured as a beacon and the caddy sensors 370 may include a sensor configured to track a position of the user sensors 220. The caddy control system 400 may receive position data from the caddy sensors 370 associated with the position of the user sensors 220 and operate the caddy 300 to follow the operator based on the position data.

According to an exemplary embodiment, the remote systems 240 and/or the caddy control system 400 of the caddy 300 are configured to generate commands or instructions that cause the caddy 300 to return to the vehicle 10. By way of example, the remote systems 240, the vehicle control system 100, and/or the caddy control system 400 may be configured to monitor various GPS and/or RTK information associated with the vehicle 10 and associated with the caddy 300. After receiving an input from the vehicle user interface 140 and/or from the caddy user interface 360 associated with the caddy 300 returning to the vehicle 10, the remote systems 240, the vehicle control system 100, and/or the caddy control system 400 may determine a first position of the vehicle 10, a second position of the caddy 300, and commands or instructions for the caddy 300 to drive the caddy 300 from the second position of the caddy 300 towards the first position of the vehicle 10. The commands or instructions may include control inputs for the caddy driveline 320 that cause the caddy driveline 320 to propel the caddy 300 from the second position of the caddy 300 towards the first position of the vehicle 10. As a result, the caddy 300 may be able to automatically return to the vehicle 10 after an operator determines that they desire for the caddy 300 to return to the vehicle 10 (e.g., after the operator has hit a golf ball and returned a golf club to the caddy 300, etc.). In some embodiments, the caddy 300 is configured to automatically return to the vehicle 10 in response to sensing that a golf club has been re-inserted into the bag 336 (e.g., after being removed by the operator to hit a golf ball).

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A caddy system for a golf vehicle, the caddy system comprising:
a caddy including:
a frame;
a plurality of tractive elements coupled to the frame; and
a carriage configured to receive and support a golf bag, the carriage pivotably coupled to the frame such that a lower end of the caddy can be pivoted to a raised position to be received by the golf vehicle.

2. The caddy system of claim 1, wherein the caddy includes a first interface configured to releasably couple to a second interface of the golf vehicle to releasably couple the caddy to the golf vehicle when the caddy is received and supported by the golf vehicle.

3. The caddy system of claim 2, further comprising a user interface configured to facilitate disengaging the first interface from the second interface.

4. The caddy system of claim 3, wherein the user interface is located on the caddy.

5. The caddy system of claim 3, wherein the user interface is configured to be located on the golf vehicle.

6. The caddy system of claim 2, further comprising a well configured to be coupled to the golf vehicle, wherein the well is configured to receive the lower end of the caddy, wherein the lower end of the caddy includes the first interface, and wherein the well includes the second interface.

7. The caddy system of claim 2, further comprising a retainer assembly configured to be coupled to the golf vehicle, wherein the retainer assembly is configured to engage with an upper end of the caddy, wherein the upper end of the caddy includes the first interface, and wherein the retainer assembly includes the second interface.

8. The caddy system of claim 2, wherein the caddy includes a battery configured to store electrical energy and provide the electrical energy to components of the caddy, wherein the first interface is electrically coupled to the battery, and wherein the first interface is configured to electrically couple to the second interface to receive electrical energy from energy storage of the golf vehicle to charge the battery.

9. The caddy system of claim 1, wherein the caddy includes a locking mechanism configured to facilitate selectively preventing the carriage from being pivoted relative to the frame.

10. The caddy system of claim 1 wherein the caddy includes a handle assembly coupled to the carriage, the handle assembly including:
an extension portion slidably coupled to the carriage; and
a handle coupled to the extension portion, wherein the extension portion is configured to slide relative to the carriage to move the handle between an extended position and a retracted position.

11. The caddy system of claim 1, wherein the frame comprises:
a first frame portion;
a second frame portion pivotably coupled to the first frame portion; and
a third frame portion pivotably coupled to the first frame portion and slidably coupled to the second frame portion, the third frame portion configured to slide along at least a portion of a length of the second frame portion.

12. The caddy system of claim 11, wherein:
the second frame portion is pivotably coupled to the first frame portion at a first end of the first frame portion;
the third frame portion is pivotably coupled to the first frame portion at a second opposing end of the first frame portion; and
when the frame is moved from an expanded configuration to a collapsed configuration, the third frame portion slides along the second frame portion towards the first end of the first frame portion.

13. The caddy of claim 12, wherein:
the plurality of tractive elements include a front tractive element and a rear tractive element;
the rear tractive element is positioned between the front tractive element and the second opposing end of the first frame portion;
the rear tractive element positioned a first distance from the carriage when the frame is in the expanded configuration; and
the rear tractive element is positioned a second distance from the carriage when the frame is in the collapsed configuration, the second distance less than the first distance.

14. A caddy system for a golf vehicle, the caddy system comprising:
a well configured to be coupled to the golf vehicle; and
a caddy including:
a frame,
a plurality of tractive elements coupled to the frame, and
a carriage pivotably coupled to the frame such that a lower end of the caddy can be pivoted to a raised position to be received by the well when the well is coupled to the golf vehicle.

15. The caddy system of claim 14, wherein the well includes a first interface, and wherein the caddy includes a second interface configured to releasably couple to the first interface to releasably couple the caddy to well when the lower end of the caddy is received and supported by the well, further comprising a user interface configured to facilitate disengaging the first interface from the second interface.

16. The caddy system of claim 14, further comprising:
a retainer assembly configured to be coupled to the golf vehicle, wherein the retainer assembly is configured to engage with an upper end of the caddy, wherein the retainer assembly includes a first interface, and wherein the upper end of the caddy includes a second interface configured to releasably couple to the first interface to releasably couple the caddy to retainer assembly when the lower end of the caddy is received and supported by the well; and
a user interface configured to facilitate disengaging the first interface from the second interface

17. The caddy system of claim 14, wherein the frame includes:
a first frame portion;
a second frame portion pivotably coupled to a first end of the first frame portion; and
a third frame portion pivotably coupled to a second opposing end of the first frame portion and slidably coupled to the second frame portion, the third frame portion configured to slide along at least a portion of a length of the second frame portion;
wherein when the frame is moved from an expanded configuration to a collapsed configuration, the third frame portion slides along the second frame portion towards the first end of the first frame portion.

18. A caddy system for a golf vehicle, the caddy system comprising:
a well configured to be coupled to the golf vehicle;
a retainer assembly configured to be coupled to the golf vehicle above the well, at least one of the well or the retainer assembly including a first interface; and
a caddy including:
a frame;
a plurality of tractive elements coupled to the frame;
a carriage pivotably coupled to the frame such that a lower end of the caddy can be pivoted to a raised position to be received by the well when the well is coupled to the golf vehicle; and
a second interface configured to releasably couple to the first interface when the lower end of the caddy is received and supported by the well.

19. The caddy system of claim 18, further comprising a user interface configured to facilitate disengaging the first interface from the second interface.

20. The caddy system of claim 18, wherein the caddy includes a battery configured to store electrical energy and provide the electrical energy to components of the caddy, wherein the second interface is electrically coupled to the battery, and wherein the second interface is configured to electrically couple to the first interface to receive electrical energy from energy storage of the golf vehicle to charge the battery.
